(19) United States
(12) Patent Application Publication
(10) Pub. No.: US 2002/0187027 A1
(43) Pub. Date: Dec. 12, 2002

(54) Keg transport device

(76) Inventors: Bill Colini, Windsor (CA); Jim Parent, Windsor (CA)

Correspondence Address: H. Roger Hart, Bereskin & Parr, Box 401, 40 King Street West, Toronto, ON, M5H 3Y2, CA

(21) Appl. No.: 09/875,163

(22) Filed: Jun. 7, 2001

(51) Int. Cl. B62B 1/06

(52) U.S. Cl. 414/444

(57) ABSTRACT

The present invention is directed to a manual transport device for user in transporting a keg. The keg has a hand hole, typically near the top of the keg. The transport device includes a frame, an engagement member, a stabilizer and a rolling member. The engagement means is located on the frame so that, in use, the engagement means engages the hand hole on the keg and substantially supports the keg. The device thus supports the keg free of any support members extending from the bottom of the device to support the underside of the keg. The stabilizer is attached to the frame and, in use, inhibits lateral movement of the keg relative to the frame. The rolling member is attached to the frame and is adapted to support the frame so that the transport device may be rolled along a surface when engaging the keg.

### FIELD OF THE INVENTION

The present invention relates to manual transport devices, and more particularly the invention relates to manual transport devices for transporting kegs with hand holes.

### BACKGROUND OF THE INVENTION

Over the years beer kegs have become generally standardized dimensionally. A typical beer keg is generally cylindrical shaped and weighs approximately 140 lbs when full. Hotels and bars keep an inventory of such kegs for their day-to-day operations, and regularly transport the kegs from an inventory area to a bar area for use.

Because of its weight, the beer keg is usually transported using a manual transport device similar to a dolly. The transport device includes a frame with a lower platform that is positioned near the base of the transport device. In use, the keg rests on the lower platform and is substantially entirely supported by the platform. To transport a keg, a person must first tip the keg forwardly to lift the near edge of the keg up from the floor or surface on which the keg is sifting. With the keg tipped in this fashion, the person maneuvers the platform underneath the underside of the keg, and tips the device and keg together backwards so that the keg is supported by the platform and rests against the frame. The device is then rolled from the inventory area to the bar area for use. To unload the keg from the device, the device is tipped upright, and the keg is held in place by the operator to ensure that it does not fall off the device accidentally. To unload the keg from the transport device, the keg is again tipped forwardly so that the platform can be extracted from beneath the keg.

Because the keg is not securely held in place laterally on the device the keg can fall off the device during loading, unloading and transport. If a keg is dropped, the beer inside may foam up and if this occurs, the beer in the keg cannot be satisfactorily dispensed for a period of approximately 24 hours. Thus, in the event of such an accident, the keg is returned to inventory and a new keg is brought out. Furthermore, dropping a keg is dangerous to both the operator and to nearby people.

Also, the loading and unloading operation of the keg on the device is cumbersome and inefficient, particularly for operators who are smaller or who weigh relatively little.

Consequently, there is a need for a keg transport device that is easy and quick to use and that reduces the risk of dropping a keg during use.

### SUMMARY OF THE INVENTION

In a first aspect, the present invention is directed to a manual transport device for use in transporting a keg having a hand hole. The transport device includes a frame, engagement means, stabilizer means and rolling means. The engagement means is located on the frame so that, in use, the engagement means engages the hand hole on the keg and substantially supports the keg. The stabilizer means is attached to the frame and is adapted to contact the keg to inhibit lateral movement of the keg relative to the frame. The rolling means is attached to the frame and is adapted to support the frame so that the transport device may be rolled along a surface when engaging the keg.

In a preferred embodiment of the first aspect of the invention, the engagement means includes a hook.

In another preferred embodiment of the first aspect of the invention, the engagement means is adaptable for kegs having different height hand holes.

In another preferred embodiment of the first aspect of the invention, the stabilizer means includes a plurality of planar segments approximating the shape of a portion of the body of the keg.

In another preferred embodiment of the first aspect of the invention, the frame has a front face, the engagement means projects forwardly of the frame, the stabilizer means projects forwardly of the frame and is located on the frame intermediate the engagement means and the rolling means, and the transport device is free of any members projecting forwardly for contacting the underside of the keg.

In a second aspect, the present invention is directed to a manual transport device for use in transporting a keg having a hand hole. The transport device includes a frame, a hook, a stabilizer and a rolling member. The hook is located on the frame so that, in use, the hook engages the hand hole on the keg and substantially supports the keg. The stabilizer is attached to the frame and is adapted to contact the keg to inhibit lateral movement of the keg relative to the frame. The rolling member is attached to the frame and is adapted to support the frame so that the transport device may be rolled along a surface when engaging the keg.

In a third aspect, the present invention is directed to a manual transport device for use in transporting a keg having a side wall and an underside. The transport device includes a frame, a support member, a stabilizer and a rolling member. The support member is attached to the frame so that, in use, the support member supports the keg free of any support of the underside of the keg. The stabilizer is attached to the frame and is adapted to contact the keg to inhibit lateral movement of the keg relative to the frame. The rolling member is attached to the frame and is adapted to support the frame so that the transport device may be rolled along a surface when engaging the keg.

### BRIEF DESCRIPTION OF THE DRAWINGS

The present invention will now be described by way of example only with reference to the attached drawings in which:

FIG. 1a is a perspective view of a keg, which is known in the prior art;

FIG. 1b is a sectional side elevation view of the keg of FIG. 1a;

FIG. 2a is a front elevation view of the transport device in accordance with a preferred embodiment of the present invention;

FIG. 2b is a side elevation view of the transport device shown in FIG. 3a;

FIG. 2c is a top plan view of the stabilizer portion of the device shown in FIG. 2a;

FIG. 2d is a top plan view of an alternative stabilizer for use on a device in accordance with another preferred embodiment of the present invention;

FIG. 3a is a side elevation view of the transport device shown in FIG. 2a in a first engagement position with a keg;

FIG. 3b is a side elevation view of the transport device shown in FIG. 2a in a second engagement position with a keg;

FIG. 3c is a side elevation view of the transport device shown in FIG. 2a in a third engagement position with a keg;

FIG. 4 is a top plan view of the transport device and keg in the position shown in FIG. 3b;

FIG. 5 is a side elevation view of the transport device in accordance with another preferred embodiment of the present invention;

FIG. 6a is a side elevation view of a transport device in accordance with another preferred embodiment of the present invention;

FIG. 6b is a magnified top plan view of a portion of the transport device shown in FIG. 6a, along line 6b-6b; and

FIG. 7 is a side elevation view of a transport device in accordance with another preferred embodiment of the present invention.

### DETAILED DESCRIPTION OF THE INVENTION

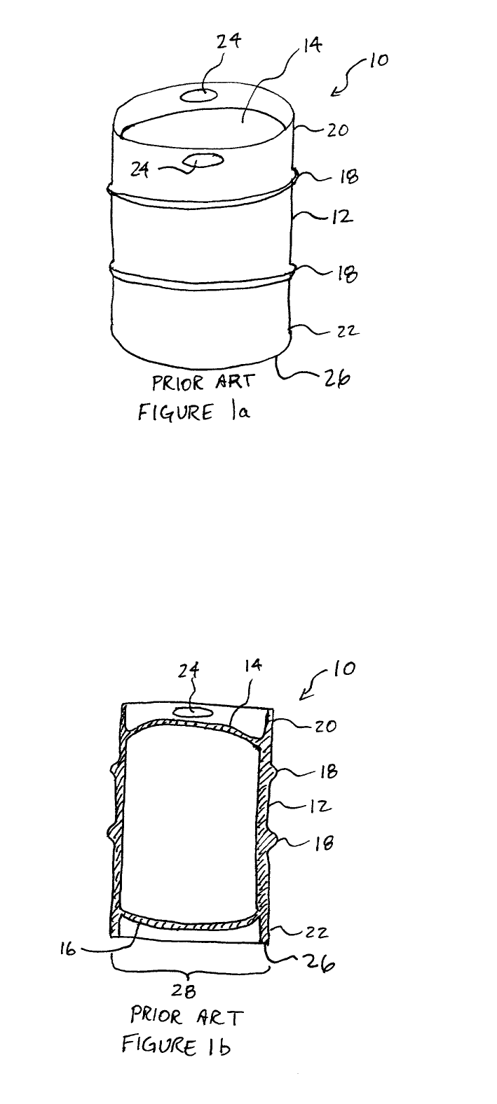

Reference is first made to FIGS. 1a and 1b, which show a typical beer keg 10 of the prior art. Keg 10, when full of beer, can weigh approximately 140 lbs, for example. Keg 10 has a generally cylindrical side wall 12 and upper and lower ends 14 and 16. Typically, a pair of rolling ribs 18 are located on side wall 12. Keg 10 can be positioned on its side so that rolling ribs 18 contact the floor or other surface, and support keg 10. Keg 10 can thus be rolled along the floor using rolling ribs 18.

Upper and lower ends 14 and 16 are generally domed, so that keg 10 can contain a minimum internal pressure without deforming. Side wall 12 has upper and lower extensions 20 and 22, which typically extend past the level of upper and lower ends 14 and 16. Upper extension 20 typically includes two hand holes 24, which can be used by an operator to maneuver keg 10 as desired. Lower extension 22 has a support rim 26, which is used to support keg 10 upright on the floor or other surface. An underside of keg 10 is shown generally at 28, and includes all surfaces on the underside of keg 10, including the bottom surface of end 16 and support rim 26.

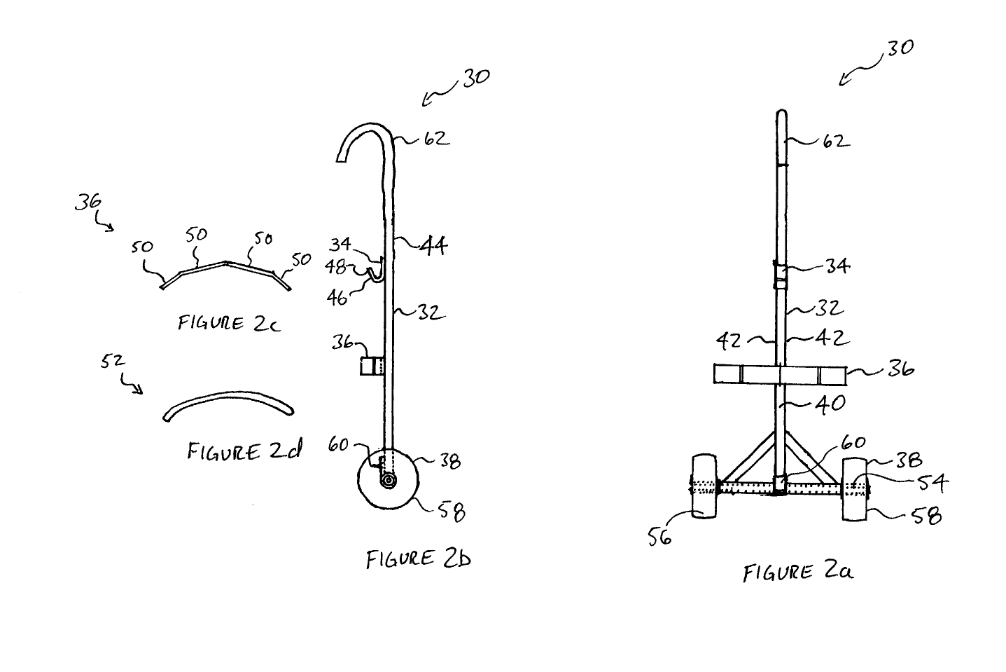

Reference is now made to FIGS. 2a and 2b, which show a manual transport device illustrated generally at 30 in accordance with a first preferred embodiment of the present invention. Device 30 includes a frame 32, engagement means such as an engagement member 34, stabilizing means such as a stabilizer 36 and rolling means such as a rolling member 38. Device 30 is adapted for transporting keg 10, and supports keg 10 by the engagement of engagement member 34 with hand hole 24. Thus, keg 10 is supported on device 30 by engagement member 34. Device 30 is free of any support means (e.g. forks, hoops, plates and the like), for supporting keg 10 from the underside 28.

Frame 32 is constructed of a suitably strong material for transporting kegs, such as heavy walled steel tubing. Frame 32 has a front face 40, side faces 42 and a rear face 44. Engagement member 34 comprises a hook 46, which is welded or otherwise attached to front face 40 of frame 32. Hook 46 has a tine 48, which extends upwards from the bight to engage hand hole 24. Tine 48 is shaped and angled suitably and hook 46 is positioned on frame 32 at a suitable height so that hook 46 can engage hand hole 24 on keg 10 without lifting keg 10, as is discussed further below.

Reference is now made to FIG. 2c, which shows stabilizer 36. Stabilizer 36 has the approximate shape of a portion of side wall 12 of keg 10. Stabilizer 36 is constructed of a suitable metal, such as flat steel bar. Stabilizer 36 is preferably welded to front face 40 of frame 32, but may alternatively be attached in any suitable manner to frame 32. Stabilizer 36 is preferably attached to frame 32 at a suitable height to avoid contacting either of ribs 18, so that keg 10 rests more closely against frame 32. Stabilizer 36 includes a plurality of segments 50. Segments 50 are joined end-to-end at a suitable angle, thereby approximating a portion of the circular shape of side wall 12. Alternatively, as shown in FIG. 2d, an alternate stabilizing means can be used, such as stabilizer 52, which comprises an arcuate part-hoop shaped member for contacting keg side wall 12.

Reference is again made is FIGS. 2a and 2b. Rolling member 38 comprises an axle 54 and two wheels 56 and 58 mounted thereto, adjacent the ends of axle 54. Axle 54 is mounted into frame 32 adjacent the bottom of frame 32. Wheels 56 and 58 are rotatably mounted to axle 54. Because wheels 56 and 58 are each rotatably mounted to axle 54, each wheel 56 and 58 can rotate at different speeds, facilitating the negotiation of turns or corners.

A small pad 60 is mounted at the bottom of frame 32. Pad 60 provides a contact surface for the lower portion of keg 10.

A handle 62 is located at the top of frame 32. Handle 62 comprises a forwardly curved member, which facilitates easy single-handed grasping by the operator.

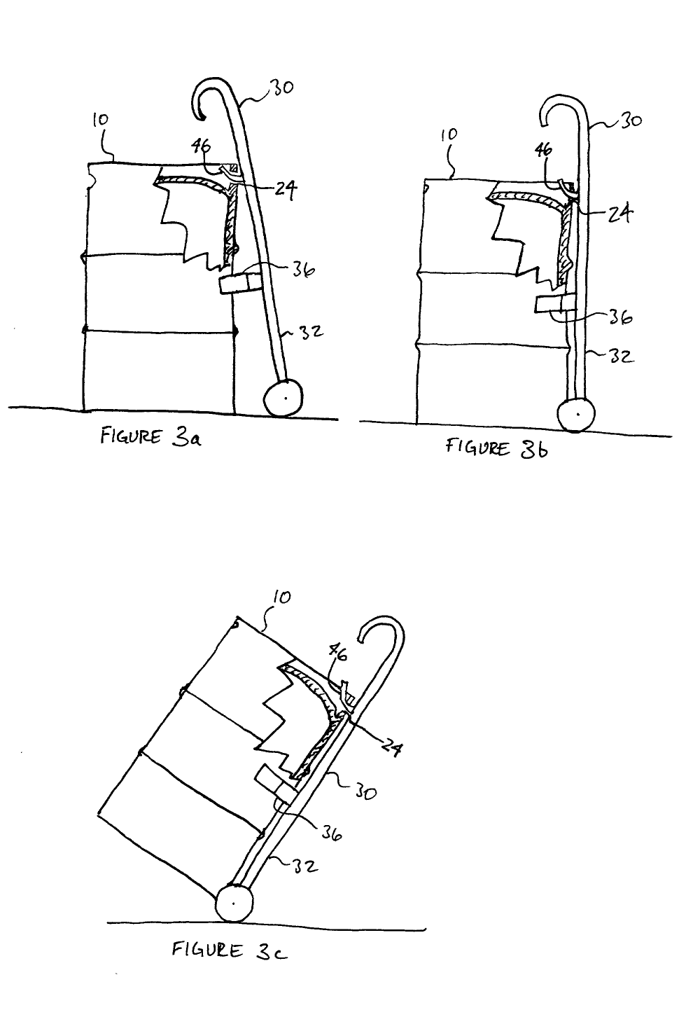

FIGS. 3a, 3b and 3c illustrate the loading, unloading and transporting of keg 10, using device 30. Reference is now made to FIG. 3a. To load keg 10 on device 30, device 30 is first positioned in a first position, as shown. In this first position, device 30 is tilted slightly forwardly towards keg 10, so that tine 48 passes through hand hole 24. Device 30 is then tilted upright to a second position as shown in FIG. 3b. Keg 10 preferably is not lifted as device 30 passes from the first position to the second position. In the second position, hook 46 projects more fully through hand hole 24. Device 30 is then moved in a third position, as shown in FIG. 3c, wherein device 30 and keg 10 are tilted rearwardly for transporting. To move from the second position to the third position, the operator prevents device 30 from rolling backwards, preferably by placing a foot on the bottom of frame 32, and pulling back on handle 62. As device 30 is tilted into the third position, the bight of hook 46 engages hand hole 24 and keg 10 is lifted off the floor by hook 46. The lifting force on keg 10 to raise keg 10 off the floor is provide by hook 46. While in the third position, keg 10 is supported by hook 46. In the third position, keg 10 rests against stabilizer 36, which inhibits keg 10 from lateral movement relative to frame 32.

Once keg 10 is positioned in the third position, it can be transported from, for example, an inventory area to a bar area for use. During transport, device 30 can be pulled up steps or curbs and the like, with a reduced risk to dropping keg 10.

Once keg 10 is brought to its destination, and it is desired to unload keg 10 from device 30, the operator first prevents device 30 from rolling rearwardly, preferably by placing a foot on the bottom of frame 32. Device 30 is then rotated from the third position, back to the second position, bringing keg 10 to rest on the floor. Device 30 is then tilted forwardly into the first position, moving the bottom of frame 32 slightly away from keg 10. Once in the first position, hook 46 can be withdrawn from hand hole 24 in keg 10.

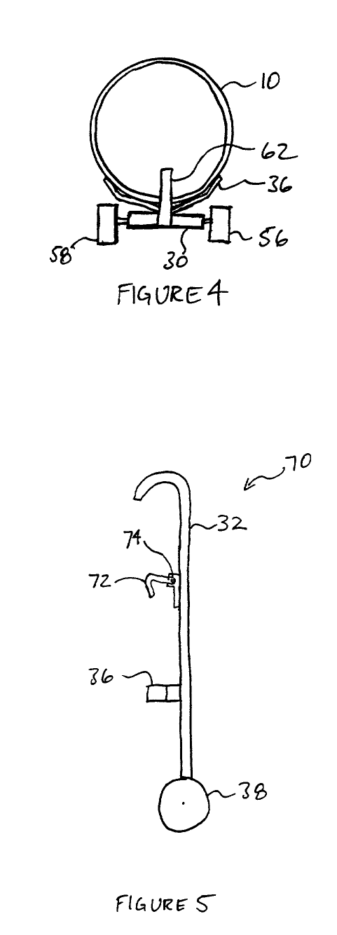

Reference is now made to FIG. 4. As shown in FIG. 4, frame 32 is preferably less wide than the diameter of keg 10. This permits device 30 to remove a keg from within any alley in which keg 10 can be located. Wheels 56 and 58 are spaced far enough apart and are of small enough diameter so as not to interfere with the transport and supporting of keg 10 on device 30.

Reference is now made to FIG. 5, which shows a device 70 in accordance with an alternate embodiment of the present invention. Device 70 is similar to device 30, except that device 70 has an alternative engagement means, which is engagement member 72. Component parts of device 70 that are the same as those in device 30 are identified with the same reference number. Thus, device 70 comprises frame 32, stabilizer 36, rolling member 38 and engagement member 72. Engagement member 72 comprises a hook 74 and a hinge pivot 76. Hook 74 engages hand hole 24 from the inside outwards and is hingeably mounted to frame 32 by hinge pivot 76. To load keg 10 on device 70, device 70 can be positioned upright directly adjacent keg 10, with hook 74 swung up to clear the top of upper extension 20. Hook 74 can then be lowered to pass through hand hole 24 of keg 10 from the inside outwards, so that hook 74 fully engages hand hole 24. Device 70 can then be tilted rearwardly while preventing rearward rolling of frame 32, thus lifting keg 10 off the floor for transport. To unload keg 10 from device 70, the loading operations are performed in reverse. Device 70 is tilted upright, while preventing rearward rolling of frame 32. Then hook 74 is rotated upwards, removing hook 72 from hand hole 24. Hook 74 is rotated sufficiently upwards to clear the top of upper extension 20. Device 70 can then be rolled away from keg 10.

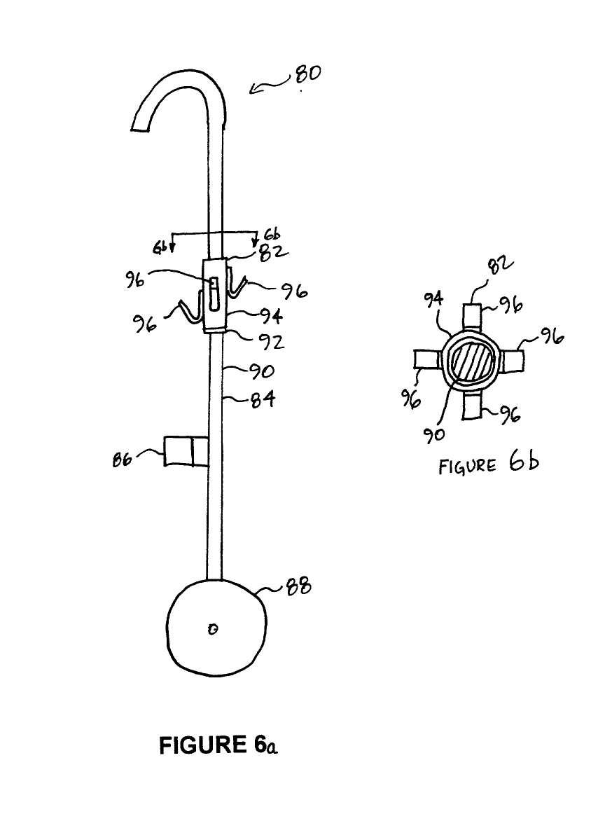

Reference is now made to FIGS. 6a and 6b, which show a device 80 in accordance with an alternate embodiment of the present invention. Device 80 is similar to device 30, but includes an alternative engagement means, which is an adjustable engagement member 82. Engagement member 82 facilitates the transporting of kegs having hand holes at different heights. Thus, device 80 has a frame 84, a stabilizer 86, a rolling member 88 and adjustable engagement member 82. Stabilizer 86 is similar to stabilizer 36 of device 30, and extends forwardly from device 80. Rolling member 88 is similar to rolling member 38 on device 30.

Frame 84 is similar to frame 32, but includes a vertical strut 90 made from round bar or round tubing. A small flange 92 extends radially with respect to strut 90 to support engagement member 82.

Engagement member 82 includes a cylindrical sleeve 94 which fits loosely on strut 90 and is rotatable thereon. Sleeve 94 is supported by flange 92. About the outside surface of sleeve 94, are a plurality of hooks 96 at various heights. Depending on the height of the hand hole on the keg to be transported, sleeve 94 can be rotated so that a selected hook 96 having a height suitable to engage the hand hole extends forwardly from the frame 84. Device 80 can then be used similarly to device 30 to lift and transport kegs. During lifting and transport it is unnecessary to lock engagement member 82 rotationally, since stabilizing member 86 prevents the keg from lateral movement.

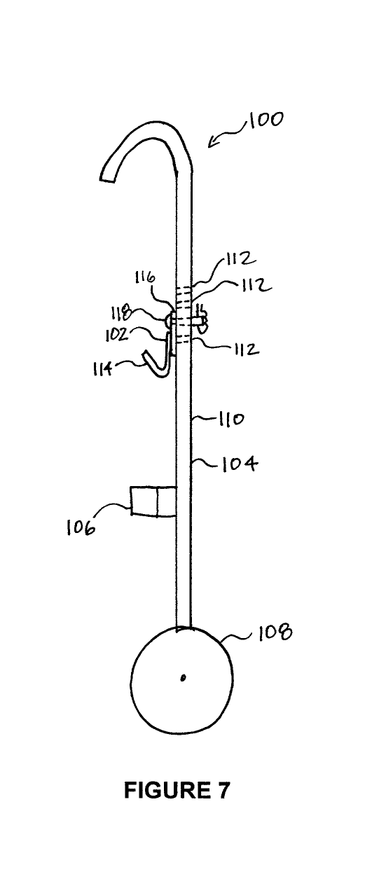

Reference is now made to FIG. 7, which shows a device 100 in accordance with another alternate embodiment of the present invention. Like device 80, device 100 includes a different engagement means, which is an adjustable engagement member 102. Device 100 includes a frame 104, a stabilizing member 106, a rolling member 108 and adjustable engagement member 102. Stabilizer 106 is similar to stabilizer 36 of device 30, and extends forwardly from frame 104. Rolling member 108 is similar to rolling member 38 on device 30.

Frame 104 includes a vertical strut 110, that may be made from any suitable metal bar or tubing, such as round, rectangular or square, for example. Strut 110 includes a plurality of holes 112, which are positioned at various heights, for the attachment of engagement member 102.

Engagement member 102 includes a hook 114 and a mounting plate 116 which has a hole therethrough. A fastener 118, such as a mushroom-headed locking pin and hairpin as shown, are used to secure engagement member 102 to strut 110. Engagement member 102 can be secured to strut 110 using any one of holes 112, so that hook 114 is positioned at a suitable height to engage a hand hole on a keg.

It will be noted that devices 30, 70, 80 and 100 are free of any support structure for supporting the underside 28 of keg 10. Thus, during the loading and unloading of keg 10, keg 10 did not require tipping forward for the insertion or removal of any support structure from underneath keg 10. Furthermore, during the loading, unloading and transport of keg 10, keg 10 is supported free of any support members of devices 30, 70, 80 and 100 contacting the underside 28 of keg 10, and is instead support substantially by the engagement of hook 46 or 72 (depending on the embodiment) with hand hole 24.

In the preferred embodiment, the transport device engages hand hole 24 initially without lifting keg 10. Alternatively, the transport device can engage kegs having hand holes located at a lower height from the floor than hand hole 24 on keg 10. Thus, when the transport device moves from the first position to the second position, the keg is lifted off the floor.

In the preferred embodiments, the stabilizing means comprises a segmented or part-hoop shaped member. Alternatively, however, the stabilizing means can comprise any suitable stabilizer member for preventing lateral movement of keg 10 during transport.

In the preferred embodiments, the engagement means comprises a hook. Alternatively, the engagement means can comprise any other suitable engagement member for engaging hand hole 24 on keg 10, so that keg 10 is substantially supported by engagement with hand hole 24 during transport.

The transport device of the present invention can be used to transport full kegs of beer, or other similarly dimensioned kegs, which, when full of a product, are relatively heavy or awkward to maneuver and transport manually. The transport device can also used to transport empty kegs.

In the preferred embodiments, the rolling means comprises an axle with two wheels rotatably mounted thereto. Alternatively, however, the rolling means can comprise any other type of suitable rolling member.

Using a device in accordance with the present invention permits quick loading and unloading of a keg, while reducing the risk of the keg dropping during transport.

As will be apparent to persons skilled in the art, various modifications and adaptations of the apparatus described above without departure from the present invention, the scope of which is defined in the appended claims.

1. A manual transport device for use in transporting a keg, said keg having a hand hole, said transport device comprising:
a frame;
engagement means, said engagement means located on said frame so that, in use, said engagement means engages said hand hole on said keg and substantially supports said keg;
stabilizer means, said stabilizer means attached to said frame and adapted to contact said keg to inhibit lateral movement of said keg relative to said frame; and
rolling means, said rolling means attached to said frame and adapted to support said frame so that said transport device may be rolled along a surface when engaging said keg.

2. A transport device as claimed in claim 1, wherein said engagement means comprises a hook.

3. A transport device as claimed in claim 1, wherein said engagement means is adjustably connected to said frame.

4. A transport device as claimed in claim 3, wherein said frame comprises a substantially vertical strut and wherein said engagement means comprises a sleeve, at least one hook attached to said sleeve and a support flange for rotatably supporting said sleeve on said strut.

5. A transport device as claimed in claim 3, wherein said frame has at least one hole therethrough and said engagement member comprises a mounting plate and a hook attached to said mounting plate, said mounting plate having a hole therethrough for aligning with one of said holes on said frame, for the insertion of a fastener for attaching said engagement member to said frame.

6. A transport device as claimed in claim 1, wherein said stabilizer means comprises a part-hoop shaped member.

7. A transport device as claimed in claim 6, wherein said stabilizer means comprises a plurality of planar segments approximating the shape of a portion of the body of said keg.

8. A transport device as claimed in claim 1, wherein said device has an overall width that is less than the diameter of said keg.

9. A transport device as claimed in claim 1, wherein:
said frame has a front face;
said engagement means projects forwardly of said frame;
said stabilizer means projects forwardly of said frame and is located on said frame intermediate said engagement means and said rolling means; and
said transport device is free of any members projecting forwardly for contacting the underside of said keg.

10. A transport device as claimed in claim 1, wherein said frame has a front face and includes a forwardly curved handle portion.

11. A transport device as claimed in claim 1, wherein said rolling means comprises two wheels attached to an axle.

12. A transport device as claimed in claim 11, wherein said frame comprises an upwardly extending strut, said frame has a front face, two side faces and a rear face, said axle extends laterally on both sides adjacent the bottom of said strut, and said wheels are positioned adjacent the ends of said axle.

13. A transport device as claimed in claim 1, wherein said engagement means comprises a hook, said hook being attached to said frame and adapted to engage said hand hole from the inside outwards.

14. A transport device as claimed in claim 13, wherein said engagement means comprises a hinge pivot, said hinge pivot hingeably attaching said hook to said frame and permitting said hook to swing upwards to clear the top of said keg.

15. A manual transport device for use in transporting a keg, said keg having a hand hole, said transport device comprising:
a frame;
a hook, said hook located on said frame so that, in use, said hook engages said hand hole on said keg and substantially supports said keg;
a stabilizer, said stabilizer attached to said frame and adapted to contact said keg to inhibit lateral movement of said keg relative to said frame; and
a rolling member, said rolling member attached to said frame and adapted to support said frame so that said transport device may be rolled along a surface when engaging said keg.

16. A manual transport device as claimed in claim 15, wherein said stabilizer comprises a part-hoop shaped member.

17. A transport device as claimed in claim 15, wherein said stabilizer comprises a plurality of planar segments approximating the shape of a portion of the body of said keg.

18. A transport device as claimed in claim 15, wherein said rolling member comprises two wheels attached to an axle.

19. A manual transport device for use in transporting a keg, said keg having a side wall and an underside, said transport device comprising:
a frame;
a support member, said support member attached to said frame so that, in use, said support member substantially supports said keg free of any support of said underside of said keg;
a stabilizer, said stabilizer attached to said frame and adapted to contact said keg to inhibit lateral movement of said keg relative to said frame; and
a rolling member, said rolling member attached to said frame and adapted to support said frame so that said transport device may be rolled along a surface when engaging said keg.

20. A manual transport device for use in transporting a keg, said keg having a side wall, a hand hole and an underside, said transport device comprising:
a frame including an upwardly extending single strut;
a hook, said hook attached to said strut so that, in use, said hook engages said hand hole and substantially supports said keg and
wherein said hook substantially entirely supports said keg free of any substantial support of said underside of said keg;
a stabilizer, said stabilizer attached to said strut and including a plurality of planar segments approximating the shape of a portion of the side wall of said keg, said stabilizer adapted to contact said keg to inhibit lateral movement of said keg relative to said frame; and
an axle attached to said frame and two wheels attached to said axle, said wheels and axle being adapted to support said frame so that said transport device may be rolled along a surface when engaging said keg.
